(19) United States
(12) Patent Application Publication
(10) Pub. No.: US 2015/0353675 A1
(43) Pub. Date: Dec. 10, 2015

(54) CATALYTIC SYSTEMS FOR THERMOSETTING RESINS WHICH ARE DEFORMABLE IN THE THERMOSET STATE

(71) Applicants: ARKEMA FRANCE, Colombes (FR); CENTRE NATIONAL DE LA RECHERCHE SCIENTIFIQUE, Paris (FR); FONDS DE L'ESPCI-GEORGES CHARPAK, Paris (FR)

(72) Inventors: Christophe DUQUENNE, Paris (FR); Ludwik LEIBLER, Paris (FR); Michel MELAS, Verneuil En Halatte (FR)

(73) Assignees: ARKEMA FRANCE, Colombes (FR); CENTRE NATIONAL DE LA RECHERCHE SCIENTIFIQUE, Paris (FR); FONDS DE L'ESPCI-GEORGES CHARPAK, Paris (FR)

(21) Appl. No.: 14/654,288

(22) PCT Filed: Dec. 19, 2013
(86) PCT No.: PCT/FR2013/053186

§ 371 Date: Jun. 19, 2015

(30) Foreign Application Priority Data
Dec. 21, 2012 (FR) 1262672

(51) Int. Cl. C08G 59/68; C08G 59/24; C08K 5/00; C08K 3/00

(52) U.S. Cl. CPC C08G 59/685; C08K 3/0008; C08G 59/245; C08K 5/0008

(57) ABSTRACT

The invention relates to a composition containing at least one catalyst (C1) containing at least one atom of an element (M1) chosen from: Al, Sc, Ti, Mg, Mn, Fe, Co, Ni, Cu, Zn, Zr, Sn, Hf, Pb, Si, Sb and In; a catalyst (C2) comprising at least one atom of an element (M2) chosen from alkali metals and alkaline-earth metals; a thermosetting resin and/or a hardener for a thermosetting resin. The invention also relates to the use of this composition for rendering a resin which is in the thermoset state hot-deformable and nevertheless free of any residual stress after the deformation thereof; such a resin will advantageously retain its shape even if it is subsequently subjected to high temperatures. The invention relates, moreover, to kits for preparing the composition, to a thermoset-resin-based object obtained from a composition of the invention, to a process for manufacturing objects, to a process for hot-deformation of objects and to various possible uses of the compositions and objects of the invention.

### FIELD OF THE INVENTION

The present invention relates to the use of certain catalysts for the manufacture of thermosetting resins, allowing the deformation of these resins in the thermoset state.

The term “thermosetting” resin means a monomer, oligomer, prepolymer, polymer or any macromolecule that is capable of being chemically crosslinked. The term more preferentially means a monomer, oligomer, prepolymer, polymer or any macromolecule that is capable of being chemically crosslinked when it is reacted with a hardener (also known as a crosslinking agent) in the presence of a source of energy, for example of heat or radiation, and optionally of a catalyst.

The term “thermoset” resin or resin “in the thermoset state” means a thermosetting resin that is chemically crosslinked so that its gel point is reached or exceeded. The term “gel point” means the degree of crosslinking beyond which the resin is virtually no longer soluble in solvents. Any method conventionally used by a person skilled in the art may be used to check it. Use may be made, for example, of the test described in patent application WO 97/23516, page 20. A resin is considered as being thermoset for the purposes of the invention once its gel content, i.e. the percentage of its residual mass after dissolution relative to its initial mass before dissolution, is greater than or equal to 75%.

### TECHNICAL BACKGROUND

Document WO 2011/151 584 describes thermoset materials, in particular resins and composites, which may be hot-machined. This phenomenon is made possible via transesterification reactions which may take place intrinsically in the thermoset material. Such materials result from the placing in contact of at least one “thermosetting resin precursor” comprising hydroxyl functions and/or epoxy groups and optionally ester functions with at least one hardener chosen from carboxylic acids, in the presence of at least one transesterification catalyst used in a proportion of from 5 mol % to 25 mol % of the total molar amount of hydroxyl and/or epoxy functions comprised in said thermosetting resin precursor. Said document mentions that the transesterification catalyst is advantageously chosen from metal salts of zinc, tin, magnesium, cobalt, calcium, titanium and zirconium and may also be chosen from catalysts of organic nature such as benzyldimethylamide and benzyltrimethylammonium chloride. The transesterification catalyst effectively used in one implementation example results from the dissolution of zinc acetate dihydrate in the hardener, in this instance a mixture of fatty acid dimers and trimers (Pripol® 1040). Thus, no mention is made of the use of a mixture of catalysts.

Similarly, document WO 2012/101 078 describes thermoset materials, especially resins and composites, which may be hot-machined, by means of transesterification reactions that may take place intrinsically in the thermoset material. These materials result from the placing in contact of at least one “thermosetting resin precursor” comprising hydroxyl functions and/or epoxy groups and optionally ester functions with at least one hardener chosen this time from acid anhydrides, in the presence of at least one transesterification catalyst used in a proportion of from 5 mol % to 25 mol % of the total molar amount of hydroxyl and/or epoxy functions comprised in said thermosetting resin precursor. Said document mentions that the transesterification catalyst is advantageously chosen from metal salts of zinc, tin, magnesium, cobalt, calcium, titanium and zirconium and may also be chosen from catalysts of organic nature such as benzyldimethylamide and benzyltrimethylammonium chloride. It is moreover mentioned that the transesterification catalyst is advantageously chosen from zinc acetylacetonate and benzyldimethylamide. Thus, no mention is made of the use of a mixture of catalysts.

There is still a need for deformable thermoset materials that are improved relative to those known in the prior art, especially in terms of mechanical performance. It would in particular be advantageous to increase their potential for deformation in the thermoset state, which would broaden the field of industrial applications envisagable for these materials.

There is also a need to improve the process for manufacturing and/or deforming such materials. In particular, in the course of an industrial cycle, the process used imposes constraints in terms of stability of the non-crosslinked system to allow its use (for example casting, injection, coating), and in terms of crosslinking speed, which it is generally sought to increase. The use of the transesterification catalysts of the prior art in a deformable thermoset resin as described in the abovementioned documents makes it necessary to work at a high temperature, often greater than or equal to 180° C., in order for the crosslinking time and/or the transformation time of the resin to be acceptable. To avoid potential degradation of the resin and/or to reduce the energy cost of the operation, it would therefore be useful to dispense with these high temperature conditions.

The inventors have found that the combination of certain catalysts makes it possible to satisfy, at least partially, these needs.

### DESCRIPTION OF THE INVENTION

When reference is made to ranges, expressions such as “ranging from . . . to . . .” include the limits of the range. Expressions such as “between . . . and . . .” exclude the limits of the range. Unless otherwise mentioned, the percentages expressed are mass percentages. The parameters to which reference is made are measured at atmospheric pressure and at room temperature (about 20° C.). All the embodiments described may advantageously be combined together.

A first subject of the invention is a composition comprising, or even consisting of, at least:
a catalyst (C1) comprising at least one atom of an element (M1) chosen from: Al, Sc, Ti, Mg, Mn, Fe, Co, Ni, Cu, Zn, Zr, Sn, Hf, Pb, Bi, Sb and In,
a catalyst (C2) comprising at least one atom of an element (M2) chosen from alkali metals and alkaline-earth metals,
a thermosetting resin and/or a thermosetting resin hardener.

The atom of the element (M1) or (M2) may be in the form of a solid and insoluble metal, alone or as an alloy with other metals, or in cationic form, in particular in the form of an organic or mineral salt, or alternatively in the form of an organometallic complex. According to a preferred embodiment, it is in cationic form.

A catalyst (C1) may comprise one or more elements (M1) chosen from the above list. A catalyst (C2) may comprise one or more elements (M2) chosen from the above list.

The composition may comprise one or more catalysts of (C1) type and one or more catalysts of (C2) type.

It is understood that the catalysts (C1) and (C2) are catalysts present in the composition of the invention, in addition to the catalysts that may already be intrinsically present in the thermosetting resin and/or in the hardener, due to their preparation which may be performed in the presence of catalysts in small amount, such as the preparation of carboxylic polyester resin performed using tin salt, described in document FR 2 577 231.

The term “thermosetting resin” is used within the meaning given in the preamble of the present description.

The term “hardener” denotes a crosslinking agent that is capable of crosslinking a thermosetting resin. It is generally a polyfunctional compound bearing reactive functions that are capable of reacting with reactive functions borne by the resin. Typically, the reactive functions of a hardener are amine, acid, anhydride or (meth)acrylate functions. In the context of the present invention, said hardener potentially present in the composition preferentially bears reactive functions of acid and/or anhydride type.

Catalysts (C1) and (C2)

According to one embodiment, the catalysts (C1) and (C2) are transesterification catalysts. The term “transesterification catalyst” is used in the conventional sense for a person skilled in the art. In particular it may be a compound that satisfies the test described in publication WO 2012/101 078, on pages 14-15.

The catalyst (C1) comprises at least one element (M1) chosen from: Al, Sc, Ti, Mg, Mn, Fe, Co, Ni, Cu, Zn, Zr, Sn, Hf, Pb, Bi, Sb and In. Preferably, the element (M1) is more particularly chosen from Ti, Mn, Fe, Co, Zn, Zr, Sn and Bi, preferably from Ti, Zn, Zr, Sn and Bi, more preferentially from Ti, Zn, Zr and Bi, in particular Zn and advantageously Zn (II).

According to one embodiment, the element (M1) is not Sn so as to overcome problems associated with the presence of tin in the final thermoset resin composition. Thus, according to this embodiment, the element (M1) is chosen from: Al, Sc, Ti, Mg, Mn, Fe, Co, Ni, Cu, Zn, Zr, Hf, Pb, Bi, Sb and In.

According to one embodiment, the catalyst (C1) is a compound of the element (M1) chosen from organic or mineral salts, which are advantageously hydrated, organic or mineral complexes, and organometallic molecules, and mixtures thereof.

According to a particular embodiment of the preceding, the catalyst (C1) is in the form of an organic or mineral salt of the element (M1). More preferably, it is an organic salt.

Mineral salts that may be mentioned include: phosphates, carbonates, oxides, hydroxides and sulfides, and mixtures thereof. Carbonates and oxides, in particular ZnO or ZnS, are preferred.

Organic salts that may be mentioned include:
the carboxylates comprising at least one —COO⁻ function borne by a linear or branched, saturated or unsaturated hydrocarbon-based chain containing from 1 to 40 carbon atoms, optionally interrupted with one or more heteroatoms chosen from N, O, S and P, or by one or more saturated, partially unsaturated or totally unsaturated hydrocarbon-based rings;
alkoxides comprising at least one —O^{—} function borne by a linear or branched, saturated or unsaturated hydrocarbon-based chain containing from 1 to 20 carbon atoms, optionally interrupted with one or more heteroatoms chosen from N, O, S and P, or by one or more saturated, partially unsaturated or totally unsaturated hydrocarbon-based rings;
acetylacetonates;
diketiminates;
and mixtures thereof.

Organometallic molecules that may be mentioned include: dibutyltin dilaurate (DBTDL), di-n-butyl oxostannate (DBTO), and mixtures thereof.

According to a particular embodiment of the invention, the catalyst (C1) is a compound of the element (M1) chosen from: phosphates, carbonates, oxides, hydroxides, sulfides; carboxylates comprising at least one —COO⁻ function borne by a linear or branched, saturated or unsaturated hydrocarbon-based chain containing from 1 to 40 carbon atoms, optionally interrupted with one or more heteroatoms chosen from N, O, S and P, or by one or more saturated, partially unsaturated or totally unsaturated hydrocarbon-based rings; alkoxides comprising at least one —O⁻ function borne by a linear or branched, saturated or unsaturated hydrocarbon-based chain containing from 1 to 20 carbon atoms, optionally interrupted with one or more heteroatoms chosen from N, O, S and P, or by one or more saturated, partially unsaturated or totally unsaturated hydrocarbon-based rings; acetylacetonates; diketiminates; and mixtures thereof.

According to a particular embodiment of the preceding, the catalyst (C1) is a compound of the element (M1) more particularly chosen from carboxylates, alkoxides and acetylacetonates, and mixtures thereof.

According to a particular embodiment of the preceding, the catalyst (C1) is a compound of the element (M1) chosen from carboxylates, and more particularly alkanoates and mono- or polyalkylalkanoates. Preferably, mention may be made of acetate, 2-ethylhexanoate, laurate, stearate, hydroxystearate and oleate, and mixtures thereof.

According to another particular embodiment, the catalyst (C 1) is a compound of the element (M1) chosen from hydrated or anhydrous acetylacetonates.

As catalyst (C1) that is particularly suitable for use in the invention, mention may be made of zinc acetylacetonate Zn(acac)).

As a variant of the above embodiments, the catalyst (C1) is present in the composition in the form of an “activated species”, i.e. in a form recombined with another compound of the composition, following a cation-exchange reaction between the catalyst (C1) and this other compound, which is, for example, the hardener or the resin. The exchange reaction may take place in situ in the composition or may be performed prior to its preparation. The activated species derived from the preferred catalyst (C1) results from the reaction between zinc acetate and a mixture of fatty acid dimers and trimers, such as that sold under the name Pripol® 1040 by Croda.

The catalyst (C2) comprises at least one element (M2) chosen from alkali metals and alkaline-earth metals. Preferably, the element (M2) is chosen from alkali metals and even more preferentially from Li, Na and K.

According to one embodiment, the catalyst (C2) is a compound of the element (M2) chosen from organic or mineral salts, which are advantageously hydrated, organic or mineral complexes, and mixtures thereof. These salts and complexes may be chosen from those mentioned previously with regard to the catalyst (C1).

Thus, according to a particular embodiment of the invention, the catalyst (C2) is a compound of the element (M2) chosen from: phosphates, carbonates, oxides, hydroxides, sulfides; carboxylates comprising at least one —COO⁻ function borne by a linear or branched, saturated or unsaturated hydrocarbon-based chain containing from 1 to 40 carbon atoms, optionally interrupted with one or more heteroatoms chosen from N, O, S and P, or by one or more saturated, partially unsaturated or totally unsaturated hydrocarbon-based rings; alkoxides comprising at least one —O⁻ function borne by a linear or branched, saturated or unsaturated hydrocarbon-based chain containing from 1 to 20 carbon atoms, optionally interrupted with one or more heteroatoms chosen from N, O, S and P, or by one or more saturated, partially unsaturated or totally unsaturated hydrocarbon-based rings; acetylacetonates; diketiminates; and mixtures thereof.

According to a particular embodiment of the preceding, the catalyst (C2) is a compound of the element (M2) more particularly chosen from carboxylates, alkoxides, and acetylacetonates, and mixtures thereof.

According to a particular embodiment of the preceding, the catalyst (C2) is a compound of the element (M2) chosen from the abovementioned carboxylates, and more particularly from alkanoates and mono- or polyalkylalkanoates. Mention may preferably be made of acetate, 2-ethylhexanoate, laurate, stearate, hydroxystearate and oleate, and mixtures thereof.

According to another particular embodiment, the catalyst (C2) is a compound of the element (M2) chosen from hydrated or anhydrous acetylacetonates.

As catalysts (C2) that are particularly suitable for use in the invention, mention may be made of lithium acetylacetonate, sodium acetylacetonate and potassium acetylacetonate, and mixtures thereof.

According to one variant of the above embodiments, the catalyst (C2) is introduced into the composition in the form of an activated species, as defined previously. The preferred activated species derived from the catalyst (C2) results from the reaction between lithium, sodium or potassium acetate and a mixture of fatty acid dimers and trimers, such as that sold under the name Pripol® 1040 from Croda.

The total content of catalysts (C1) and (C2) in the composition may represent from 1% to 70% by weight, preferably from 1% to 50% by weight and more preferably from 1% to 25% by weight relative to the total weight of the composition.

When the composition comprises a species activated with at least one of the catalysts (C1) or (C2), or even with both, this species being, for example, the hardener or the resin, the activated species may represent from 30% to 70% by weight relative to the total weight of the composition.

According to an embodiment in which the composition comprises at least one hardener of carboxylic acid type (comprising at least one C(O)OH function) or of carboxylic acid anhydride type (comprising at least one —C(O)—O—C(O)— function) or both, the ratio of the number of moles of atoms of elements (M1) and (M2) per mole of —C(O)OH functions or per 0.5 mole of —C(O)—O—C(O)— functions of the hardener ranges from I% to 50%, advantageously from 2% to 25% and preferably from 5% to 20%.

According to one embodiment, the weight ratio of catalyst (C1) relative to the weight of catalyst (C2) ranges from 1:10 to 10:1, from 1:2 to 2:1, preferably being 1:1.

The catalysts (C1) and (C2) are generally in solid or liquid form. When they are in solid form, they are preferably in the form of a finely divided powder.

The catalysts (C1) and (C2) may be homogeneous or heterogeneous, advantageously being homogeneous, preferably in the same phase as the resin and/or the hardener.

Thermosetting Resin

According to one embodiment, the composition of the invention comprises at least one thermosetting resin. This thermosetting resin may advantageously comprise at least one and advantageously several epoxide functions and optionally at least one and advantageously several free hydroxyl functions and/or ester functions. Such a resin will be denoted by the term “epoxy resin”.

Advantageously, the epoxy resin represents at least 10% by weight, at least 20% by weight, at least 40% by weight, at least 60% by weight or even 100% by weight relative to the total weight of thermosetting resin present in the composition.

For the purposes of the invention, the term “epoxy resin” means a molecule containing at least one epoxide group (also known as oxirane or ethoxyline), which may be represented as follows:

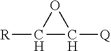

with Q═H or Q═R′, R and R′ being organic groups.

There are two major categories of epoxy resins: epoxy resins of glycidyl type and epoxy resins of non-glycidyl type. Epoxy resins of glycidyl type are themselves classified as glycidyl ether, glycidyl ester and glycidyl amine. Non-glycidyl epoxy resins are of aliphatic or cycloaliphatic type.

Glycidyl epoxy resins are prepared via a condensation reaction of a diol, diacid or diamine with epichlorohydrin. Non-glycidyl epoxy resins are formed by peroxidation of the olefinic double bonds of a polymer.

Among the glycidyl epoxy ethers, bisphenol A diglycidyl ether (BADGE) represented below is the one most commonly used.

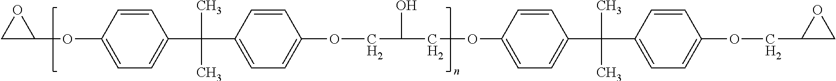

BADGE-based resins have excellent electrical properties, low shrinkage, good adhesion to numerous metals and good resistance to moisture, to mechanical impacts and good heat resistance.

The properties of BADGE resins depend on the value of the degree of polymerization n, which itself depends on the stoichiometry of the synthetic reaction. As a general rule, n ranges from zero to 25.

Novolac epoxy resins (the formula of which is represented below) are glycidyl ethers of novolac phenolic resins. They are obtained by reaction of phenol with formaldehyde in the presence of an acid catalyst to produce a novolac phenolic resin, followed by a reaction with epichlorohydrin in the presence of sodium hydroxide as catalyst.

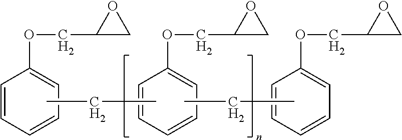

Novolac epoxy resins generally contain several epoxide groups. The multiple epoxide groups make it possible to produce thermoset resins with a high crosslinking density. Novolac epoxy resins are widely used for manufacturing microelectronic materials on account of their greater resistance to elevated temperature, their excellent moldability and their superior mechanical, electrical, heat-resistance and moisture-resistance properties.

The thermosetting resin that may be used in the present invention may be chosen, for example, from: Novolac epoxy resins, bisphenol A diglycidyl ether (BADGE), hydrogenated bisphenol A diglycidyl ether, bisphenol F diglycidyl ether, tetraglycidyl methylene dianiline, pentaerythritol tetraglycidyl ether, trimethylol triglycidyl ether (TMPTGE), tetrabromobisphenol A diglycidyl ether, or hydroquinone diglycidyl ether, ethylene glycol diglycidyl ether, propylene glycol diglycidyl ether, butylene glycol diglycidyl ether, neopentyl glycol diglycidyl ether, 1,4-butanediol diglycidyl ether, 1,6-hexanediol diglycidyl ether, cyclohexanedimethanol diglycidyl ether, polyethylene glycol diglycidyl ether, polypropylene glycol diglycidyl ether, polytetramethylene glycol diglycidyl ether, resorcinol diglycidyl ether, neopentylglycol diglycidyl ether, bisphenol A polyethylene glycol diglycidyl ether, bisphenol A polypropylene glycol diglycidyl ether, terephthalic acid diglycidyl ester, poly(glycidyl acrylate), poly(glycidyl methacrylate), epoxidized polyunsaturated fatty acids, epoxidized plant oils, especially epoxidized soybean oil, epoxidized fish oils, and epoxidized limonene; glycidyl esters of versatic acid such as those sold under the name Cardura® E8, E 10 or E12 by the company Momentive (Cardura® E 10 of CAS 26761-45-5); the epoxidized cycloaliphatic resins sold under the name Araldite® CY179, CY184, MY0510 and MY720 by the company BASF, the resins CY179 and CY184 corresponding, respectively, to the following formulae:

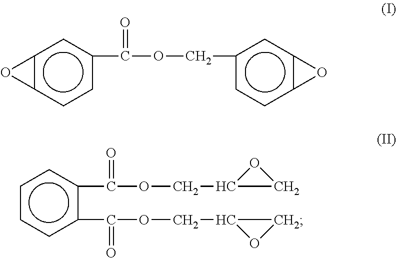

triglycidyl isocyanurate (TGIC); glycidyl methacrylate, alkoxylated glycidyl(meth)acrylates; C8-C10 alkyl glycidyl ethers, C12-C14 alkyl glycidyl ethers, neodecanoic acid glycidyl ester, butyl glycidyl ether, cresyl glycidyl ether, phenyl glycidyl ether, p-nonylphenyl glycidyl ether, p-nonylphenyl glycidyl ether, p-t-butyl phenyl glycidyl ether, 2-ethylhexyl glycidyl ether, neopentyl glycol diglycidyl ether, acid dimer diglycidyl ester, cyclohexane dimethanol diglycidyl ether, aliphatic polyglycidyl ether, castor oil polyglycidyl ether; and mixtures of the abovementioned resins.

Advantageously, it is more particularly chosen from: BADGE, bisphenol F diglycidyl ether, Novolac resins, TMPTGE, 1,4-butanediol diglycidyl ether, Araldite° CY184 of formula (II) above, TGIC, epoxidized soybean oil, and mixtures thereof.

The thermosetting resin may advantageously represent from 10% to 90% by weight, especially from 20% to 80% by weight or even from 30% to 70% by weight relative to the total weight of the composition. The remainder to 100% by weight of the composition is provided by the catalysts (C1) and (C2), the optional hardener and the optional additional compounds such as those described later.

Hardener

According to one embodiment, the composition of the invention comprises at least one hardener. This hardener may advantageously be chosen from hardeners comprising at least two carboxylic acid functions —C(O)OH or at least one acid anhydride function —C(O)—O—C(O)—, and mixtures thereof. Such a hardener is commonly known as an “acid hardener”.

According to one embodiment, the acid hardener comprises at least three acid functions (whether they are in free carboxylic acid or acid anhydride form). This makes it possible to create a three-dimensional network when such a hardener is used for crosslinking a thermosetting resin.

According to a particular embodiment, the acid hardener is chosen from long-chain acid hardeners, typically comprising from 2 to 40 carbon atoms. This makes it possible to obtain flexible thermoset resins (moderately crosslinked networks with a low Tg) when such a hardener is used for crosslinking a thermosetting resin.

As acid hardeners that may be used in accordance with the invention, mention may be made of carboxylic acids comprising from 2 to 40 carbon atoms, fatty acid derivatives, and mixtures thereof.

Acid hardeners that may also be used include linear diacids such as glutaric, adipic, pimelic, suberic, azelaic, sebacic, succinic or dodecanedioic acid and homologs thereof of higher masses; and mixtures thereof.

Acid hardeners that may also be used include aromatic diacids such as ortho-, meta- or para-phthalic acid, trimellitic acid, terephthalic acid or naphthalenedicarboxylic acid, and also more or less alkylated and/or partially hydrogenated derivatives thereof, for example (methyl)tetrahydrophthalic acid, (methyl)hexahydrophthalic acid, (methyl)nadic acid; and mixtures thereof.

The term “fatty acid derivative” in reference to the acid hardener preferably means a fatty acid, a fatty acid ester, a triglyceride, an ester of fatty acid and of fatty alcohol, a fatty acid oligomer, especially a fatty acid dimer (oligomer of 2 identical or different monomers) or a fatty acid trimer (oligomer of 3 identical or different monomers), and mixtures thereof.

Acid hardeners that may thus be used include fatty acid trimers or a mixture of fatty acid dimers and trimers, advantageously comprising from 2 to 40 carbon atoms, advantageously of plant origin. These compounds result from the oligomerization of unsaturated fatty acids such as: undecylenic, myristoleic, palmitoleic, oleic, linoleic, linolenic, ricinoleic, eicosenoic, docosenoic acid, which are usually found in pine oil, rapeseed oil, corn oil, sunflower oil, soybean oil, grapeseed oil, linseed oil and jojoba oil, and also eicosapentaenoic acid and docosahexaenoic acid, which are found in fish oils; and mixtures thereof.

Examples of fatty acid trimers that may be mentioned include the compound having the following formula, which illustrates a cyclic trimer derived from fatty acids containing 18 carbon atoms, given that the compounds that are commercially available are mixtures of steric isomers and of positional isomers of this structure, which are optionally partially or totally hydrogenated.

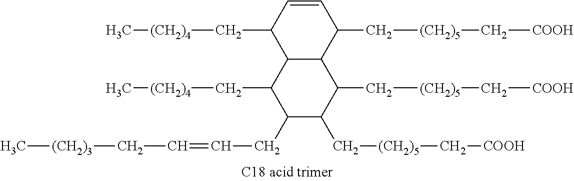

Use may be made, for example, of a mixture of fatty acid oligomers containing linear or cyclic dimers, trimers and monomers of C18 fatty acids, said mixture being predominant in dimers and trimers and containing a small percentage (usually less than 5%) of monomers. Preferably, said mixture comprises:
0.1% to 40% by weight and preferably 0.1% to 5% by weight of identical or different fatty acid monomers,
0.1% to 99% by weight and preferably 18% to 85% by weight of identical or different fatty acid dimers, and
0.1% to 90% by weight and preferably 5% to 85% by weight of identical or different fatty acid trimers.

Examples of fatty acid dimer/trimer mixtures (weight %) that may be mentioned include:
Pripol® 1017 from Croda, mixture of 75-80% dimers and 18-22% trimers with about 1-3% fatty acid monomers,
Pripol® 1048 from Croda, 50/50% mixture of dimers/trimers,
Pripol® 1013 from Croda, mixture of 95-98% dimers and 2-4% trimers with 0.2% maximum of fatty acid monomers,
Pripol® 1006 from Croda, mixture of 92-98% dimers and a maximum of 4% trimers with 0.4% maximum of fatty acid monomers,
Pripol® 1040 from Croda, mixture of fatty acid dimers and trimers with at least 75% trimers and less than 1% fatty acid monomers,
Unidyme® 60 from Arizona Chemicals, mixture of 33% dimers and 67% trimers with less than 1% fatty acid monomers,
Unidyme® 40 from Arizona Chemicals, mixture of 65% dimers and 35% trimers with less than 1% fatty acid monomers,
Unidyme® 14 from Arizona Chemicals, mixture of 94% dimers and less than 5% trimers and other higher oligomers with about 1% fatty acid monomers,
Empol® 1008 from Cognis, mixture of 92% dimers and 3% higher oligomers, essentially trimers, with about 5% fatty acid monomers,
Empol® 1018 from Cognis, mixture of 81% dimers and 14% higher oligomers, essentially trimers, with about 5% fatty acid monomers,
Radiacid® 0980 from Oleon, mixture of dimers and trimers with at least 70% trimers.

The products Pripol®, Unidyme®, Empol®, and Radiacid® comprise C18 fatty acid monomers and fatty acid oligomers corresponding to multiples of C18.

Acid hardeners that may also be mentioned include polyoxyalkylenes (polyoxyethylene, polyoxypropylene, etc.) comprising carboxylic acid functions at the ends, polymers comprising carboxylic acid functions at the ends, with a branched or unbranched structure, advantageously chosen from polyesters and polyamides and preferably from polyesters; and mixtures thereof.

An acid hardener that may also be mentioned is phosphoric acid.

According to another embodiment, the acid hardener is chosen from anhydrides. When such a hardener is used for crosslinking a thermosetting resin, it makes it possible to obtain hard thermoset resins (crosslinked networks with a Tg above room temperature, i.e. about 20° C.).

Acid hardeners of anhydride type that may especially be mentioned include cyclic anhydrides, for instance phthalic anhydride, methylnadic anhydride, dodecenylsuccinic anhydride (DDSA), glutaric anhydride; partially or totally hydrogenated aromatic anhydrides, for instance (methyl)tetrahydrophthalic anhydride, (methyl)hexahydrophthalic anhydride; and mixtures thereof. Use may especially be made of the anhydrides having the following formulae, and mixtures thereof.

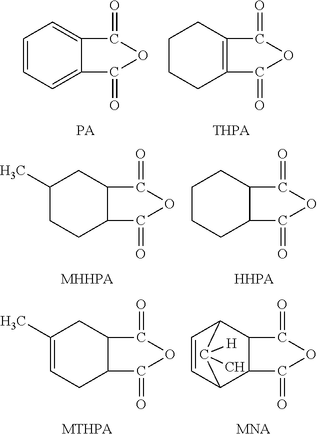

Acid hardeners of anhydride type that may also be mentioned include succinic anhydride, maleic anhydride, trimellitic anhydride, the adduct of trimellitic anhydride and ethylene glycol, chlorendic anhydride, nadic anhydride, tetrachlorophthalic anhydride, pyromellitic dianhydride (PMDA), 1,2,3,4-cyclopentanetetracarboxylic acid dianhydride, aliphatic acid polyanhydrides such as polyazelaic polyanhydride and polysebacic polyanhydride, and mixtures thereof.

An acid hardener of anhydride type that may also be mentioned is the hardener with the commercial reference HY905 sold by BASF, which is a liquid mixture of several anhydrides.

Advantageously, the acid hardener is more particularly chosen from: polyoxyalkylenes comprising carboxylic acid functions at the ends and polyesters comprising carboxylic acid functions at the ends; terephthalic acid, adipic acid, sebacic acid, succinic acid, glutaric acid, fatty acid oligomers, in particular fatty acid dimers and trimers; (hydro)phthalic anhydrides, MHHPA, MNA, MTHPA, in particular MTHPA in the form of a mixture of positional isomers of the methyl group and of the double bond, and mixtures thereof.

The hardener may advantageously represent from 10% to 90% by weight, especially from 20% to 80% by weight or even from 30% to 70% by weight relative to the total weight of the composition.

According to one embodiment, the composition comprises, or even consists of, at least the catalysts (C1) and (C2), an acid hardener and optionally an epoxy thermosetting resin, as defined above: according to this embodiment, the number of moles of atoms of the elements (M1) and (M2) may range from 1% to 50%, preferably from 1% to 25%, preferably from 5% to 20%, relative to the number of moles of carboxylic acid functions of the hardener (or to its number of moles of anhydride functions divided by 2). When the composition also comprises the resin, the number of moles of epoxide functions in the resin may range from 50% to 150%, preferably from 75% to 125%, preferably from 90% to 110%, relative to the number of moles of carboxylic acid functions in the hardener (or to its number of moles of anhydride functions divided by 2).

Additional Compounds

The composition of the invention may optionally comprise one or more additional compounds, insofar as their presence does not impair the advantageous properties arising from the invention.

These additional compounds may be chosen especially from: polymers, pigments, dyes, fillers, plasticizers, long or short, woven or nonwoven fibers, flame retardants, antioxidants, lubricants, wood, glass, metals, and mixtures thereof.

These additional compounds may represent from 1% to 90%, from 1% to 70%, from 1% to 50% or even from 1% to 25% of the total weight of the composition.

Among the polymers that may be used as a mixture with the composition of the invention, mention may be made of: elastomers, thermoplastics, thermoplastic elastomers, and impact additives.

The term “pigments” means colored particles that are insoluble in the composition of the invention. As pigments that may be used according to the invention, mention may be made of titanium oxide, carbon black, carbon nanotubes, metal particles, silica, metal oxides, metal sulfides or any other mineral pigment; mention may also be made of phthalocyanines, anthraquinones, quinacridones, dioxazines, azo pigments or any other organic pigment, natural pigments (madder, indigo, purple, cochineal, etc.) and mixtures of pigments.

The term “dyes” means molecules that are soluble in the composition of the invention and that have the capacity of absorbing part of the visible radiation.

Among the fillers that may be used in the composition of the invention, mention may be made of: silica, clays, carbon black, kaolin, talc and whiskers, and mixtures thereof.

Among the fibers that may be used in the composition of the invention, mention may be made of: glass fibers, carbon fibers, polyester fibers, polyamide fibers, aramid fibers, cellulose and nanocellulose fibers or plant fibers (flax, hemp, sisal, bamboo, etc.), and mixtures thereof.

The presence in the composition of the invention of pigments, dyes or fibers capable of absorbing radiation, or mixtures thereof, may serve to ensure the heating of a material or of an object manufactured from such a composition, by means of a source of radiation such as a laser.

The presence in the composition of the invention of pigments, fibers or electrically conductive fillers such as carbon black, carbon nanotubes, carbon fibers, metal powders, magnetic particles or mixtures thereof may be used to ensure the heating of a material or of an object manufactured from such a composition, via the Joule effect, by induction or by microwaves. Such heating may allow the use of a process for manufacturing, transforming or recycling a material or an object according to a process that will be described later.

The additional compounds may also be chosen from one or more other catalysts and/or hardeners, of any nature known to those skilled in the art as performing these roles, insofar as they do not impair the advantageous properties arising from the invention. They will be referred to as “additional catalyst” and “additional hardener”.

Use may especially be made of one or more additional transesterification catalysts and more preferentially of transesterification catalysts allowing the deformation of a thermosetting resin in the thermoset state. Such additional catalysts may be chosen from phosphines, amines, quaternary ammonium salts, and mixtures thereof.

Use may also be made of one or more additional catalysts that are specific to epoxide opening. Mention may be made of:
optionally blocked tertiary amines, for instance: 2,4,6-tris(dimethylaminomethyl)phenol (sold, for example, under the name Ancamine), o-(dimethylaminomethyl)phenol, benzyl-dimethylamine (BDMA), 1,4-diazabicyclo(2,2,2)octane (DABCO), methyltribenzylammonium chloride,
cyclic or non-cyclic guanidines, for instance triazabicyclodecene (1,5,7-triazabicyclo-[4.4.0]dec-5-ene) (TBD), 1,1,3,3-tetramethylguanidine,
amidines, such as diazabicycloundecene (DBU),
imidazoles, such as 2-methylimidazole (2-MI), 2-phenylimidazole (2-PI), 2-ethyl-4-methyl-imidazole (EMI), 1-propylimidazole, 1-ethyl-3-methylimidazolium chloride, 1-(2-hydroxypropyl)imidazole,
phosphoniums: tetraalkyl- and alkyltriphenylphosphonium halides,
amine salts of polyacids, aniline-formaldehyde condensates, N,N-alkanolamines, trialkanolamine borates, fluoroborates such as boron trifluoride monoethylamine (BF₃-MEA), organosubstituted phosphines, quaternary monoimidazoline salts, mercaptans, polysulfides,
and mixtures thereof.

Preferentially, the epoxide-opening catalyst is chosen from: tertiary amines, cyclic or non-cyclic guanidines, imidazoles, and mixtures thereof.

More preferentially, the epoxide-opening catalyst is chosen from: 2,4,6-tris-(dimethylaminomethyl)phenol, o-(dimethylaminomethyl)phenol, benzyldimethylamine (BDMA), 2-methylimidazole (2-MI), 2-phenylimidazole (2-PI), 2-ethyl-4-methylimidazole (EMI), and mixtures thereof.

According to the embodiment in which the composition comprises a thermosetting resin comprising one or more epoxide functions, when an epoxide-opening catalyst is used as additional catalyst, it is advantageously used in the composition in a proportion of from 0.1 mol % to 5 mol % relative to the number of moles of epoxide functions borne by the thermosetting resin.

Use may also be made of one or more additional catalysts chosen from the catalysts mentioned in applications WO 2011/151 584, WO 2012/101 078 and WO 2012/152 859, still insofar as their presence does not impair the advantageous properties arising from the invention.

The additional catalyst may, for example, be present in the composition of the invention in a proportion of from 0.1% to 10% by weight and preferably from 0.1% to 5% by weight relative to the total weight of the composition.

Moreover, the use of an additional hardener makes it possible to obtain, for the materials finally manufactured, a wide range of mechanical properties at room temperature (for example control of the glass transition temperature and/or of the modulus of a thermoset resin).

Examples of additional hardeners that may be mentioned include epoxy resin hardeners, chosen in particular from amines, polyamides, polycarboxylic acids (optionally other than those described above as acid hardeners), phenolic resins, anhydrides (optionally other than those described above as acid hardeners), isocyanates, polymercaptans, dicyanodiamides, and mixtures thereof.

In particular, an additional hardener of amine type may be chosen from primary or secondary amines bearing at least one NH₂ function or two NH functions and from 2 to 40 carbon atoms. These amines may be chosen, for example, from aliphatic amines such as diethylenetriamine, triethylenetetramine, tetraethylenepentamine, dihexylenetriamine, cadaverine, putrescine, hexanediamine, spermine, isophoronediamine, and also aromatic amines such as phenylenediamine, diaminodiphenylmethane, diaminodiphenylsulfone, methylenebischlorodiethylaniline, meta-xylylenediamine (MXDA) and hydrogenated derivatives thereof such as 1,3-bis(aminomethylcyclohexane) (1,3-BAC); and mixtures thereof.

An additional hardener of amine type may also be chosen from polyetheramines, for example the Jeffamine products from Huntsman, optionally as mixtures with other additional hardeners.

Preferred additional hardeners that may be mentioned include diethylenetriamine, triethylenetetramine and hexanediamine, and mixtures thereof.

An additional hardener may, for example, be present in the composition of the invention in a proportion of from 1% to 50% by weight, especially from 1% to 30% by weight and preferably from 2% to 10% by weight relative to the weight of the acid hardener; when the latter is present in the composition.

### Process for Preparing the Composition

The compounds of the composition according to the invention are either commercially available or can be readily synthesized by a person skilled in the art from commercially available starting materials.

The composition of the invention may be obtained by simple placing in contact of the compounds it contains. This placing in contact is preferably performed at a temperature ranging from 15° C. to 130° C., especially from 70° C. to 125° C. and advantageously from 100° C. to 120° C. The placing in contact may be performed with or without a homogenization means.

According to a particular embodiment, the process comprises a first step during which at least one of the catalysts (C1) and (C2) is preintroduced into the resin or the hardener. The catalyst may then be in the form of a dispersion if it is a powder, or a solution. This dispersion or dissolution may be performed at room temperature or with heating to obtain the desired viscosity characteristics.

According to another particular embodiment, the process comprises a first step of formation of an activated species, comprising the placing in contact of a hardener or of a thermosetting resin with the catalyst (C1) and/or (C2) so as to complex the atom of the element (M1) and/or (M2) of the catalyst in the hardener or the thermosetting resin. Advantageously, the hardener and/or the resin then comprises functions that are capable of releasing cations to allow exchange of these cations with cations of the element (M1) and/or (M2) of the catalyst.

The step of formation of an activated species is preferably performed at a temperature ranging from 15° C. to 220° C., especially from 70° C. to 200° C. and advantageously from 80° C. to 180° C., in one or more successive stages.

The step of formation of an activated species may be performed with or without homogenization means.

The step of formation of an activated species may advantageously be performed at reduced pressure, i.e. below atmospheric pressure, for example ranging from 45 to 55 mbar.

According to this embodiment with formation of an activated species, the preparation process comprises a second step of placing in contact of the activated species derived from then first step with the hardener and/or the thermosetting resin and the optional additional compounds, to obtain a composition in accordance with the invention. The temperature and stirring conditions of this second step are the same as those described above for the preparation of a composition in accordance with the invention.

### Kits

Another subject of the invention is a kit for preparing a composition in accordance with the invention comprising at least:
a first composition comprising at least the catalyst (C1),
a second composition comprising at least the catalyst (C2),
a third composition comprising at least the hardener and/or a fourth composition comprising at least the thermosetting resin.

A subject of the invention is also a kit for preparing a composition for manufacturing an object in accordance with the invention, comprising at least:
a first composition comprising at least the catalyst (C1),
a second composition comprising at least the catalyst (C2),
a third composition comprising at least the hardener, and
a fourth composition comprising at least the thermosetting resin.

The various compositions may be stored together or separately. It is also possible to store together some of the compositions while keeping them separated from the other compositions.

The various compositions are generally stored at room temperature.

Preferably, when the third and fourth compositions are both present in the kit, they are in a packaging that is suitable for preventing a crosslinking reaction between the thermosetting resin and the hardener from taking place without the intervention of an operator.

The packaging may consist of a container comprising two or even three or four internal compartments for separately storing each of the compositions.

According to one variant, the kit may consist of a single container, containing a mixture in suitable amounts of the two, three or four compositions. In the latter case, the intervention of the operator is advantageously limited to heating.

A means may be envisaged for the placing in contact of the contents of the various compartments, advantageously so as to make it possible to initiate the crosslinking in the container when the second and third compositions are present.

A kit may also be envisaged consisting of several distinct bottles combined in the same wrapping and each comprising the appropriate amounts of each of the compositions for the preparation of the composition of the invention, so as to avoid the user performing weighing and/or metering operations.

### Uses

Another subject of the invention is the use of a composition in accordance with the invention or of a kit as described above for rendering a thermoset resin hot-malleable, in particular a resin such as those described above.

A subject of the invention is also the use of a composition in accordance with the invention or of a kit in accordance with the invention for rendering a thermoset resin (in other words a resin that is already in the thermoset state) hot-deformable, and free of any residual constraint after its deformation. Advantageously, and contrary to a standard thermoset resin, such a resin conserves its shape resulting from the deformation, at such time that this resin is heated again.

The term “hot-”deformable means deformable at a temperature (T) above room temperature and preferentially above the glass transition temperature Tg of the thermoset resin.

The glass transition temperatures (Tg) of the resins used in the present invention may be obtained from thermomechanical measurements (DMTA) known to those skilled in the art. They may be determined by taking the temperature at the peak of the tangent delta. The machine used may be a Rheometric Scientific RDA3 in rectangular torsion mode with a frequency of 1 Hz and a degree of deformation of 0.08%, over a temperature range from −100° C. to 250° C. The sizes of the parallelepipedal sample are: 25 mm×6 mm×4 mm.

### Objects and Processes for Manufacturing Same

A subject of the invention is also an object comprising a thermoset resin obtained from at least one composition in accordance with the invention.

For the purposes of the present invention, the term “object” means a three-dimensional piece. This definition includes coatings, films, sheets, strips, etc. The objects according to the invention may especially consist of coatings deposited on a support, such as a protective layer, a paint or an adhesive film. Powders, granules, etc. are also included.

The object according to the invention is hot-deformable.

The invention also relates to a process for manufacturing an object, comprising:
a) the preparation or provision of a composition in accordance with the invention comprising at least the thermosetting resin, the hardener and the catalysts (C1) and (C2),
b) the forming of the composition obtained from step a),
c) the application of an energy for hardening the resin,
d) cooling of the thermoset resin.

Steps a), b), and c) of the process may be successive or simultaneous.

The invention also relates to an object that may be obtained via this process.

The preparation of the composition may take place in a mixer of any type known to those skilled in the art.

The preparation of the composition may take place by placing in contact the compositions described in relation to the kit so as to form a composition according to the invention.

The forming may be performed via any technique known to those skilled in the art in the field of thermosetting resins, especially by molding. Notably, the invention makes it possible also to envisage other forming methods such as casting, filament winding, continuous molding or film insert molding, infusion, pultrusion, RTM (resin transfer molding), RIM (reaction-injection molding) or other methods known to those skilled in the art, as described in the publications “Epoxy Polymer” edited by J. P. Pascault and R. J. J. Williams, Wiley-VCH, Weinheim 2010 or “Chimie Industrielle” by R. Perrin and J. P. Scharff, Dunod, Paris 1999.

The forming may consist in forming powder or grains via any technique known to those skilled in the art. Mechanical grinding may also be performed after step d).

As regards the forming of the composition in coating form, any method known in the field may advantageously be performed, in particular: application of the composition by brush or roller; dipping of a support to be coated in the composition; application of the composition in the form of a powder.

If an attempt is made to form a thermosetting resin composition of the prior art in the same manner as described above, once the resin has hardened, the material or object obtained is no longer deformable or repairable, nor recyclable. Specifically, once the gel point of the resin is reached or exceeded, the material or object made of thermosetting resin of the prior art is no longer deformable or repairable, nor recyclable. The application of a moderate temperature to such an object according to the prior art does not lead to any observable or measurable transformation, and the application of a very high temperature leads to the degradation of this object.

In contrast, due to the fact that they are manufactured from a composition in accordance with the invention, the objects of the invention may be deformed, welded, repaired and recycled by raising their temperature.

The term “application of an energy for hardening the resin” generally means a raising of temperature. The application of an energy for hardening the resin may consist, for example, in heating to a temperature ranging from 50 to 250° C. An activation by radiation may also be performed, for example with UV rays or an electron beam, or chemically, in particular via a radical means, for example using peroxides.

Cooling of the thermoset resin is usually performed by allowing the material or object to return to room temperature, with or without using a cooling means.

An object in accordance with the invention may be composite. It may especially result from the assembly of at least two objects, at least one of which, and advantageously both of them, comprises at least one thermoset resin obtained from at least one composition in accordance with the invention.

It is, for example, a sandwich material, comprising an alternating superposition of layers of thermoset resin obtained from at least one composition in accordance with the invention, with layers of wood, metal or glass.

An object of the invention may also comprise one or more additional components chosen from those mentioned previously and in particular: polymers, pigments, dyes, fillers, plasticizers, long or short, woven or nonwoven fibers, flame retardants, antioxidants, lubricants, wood, glass or metals. When such an object is manufactured in accordance with one of the manufacturing processes described above, the additional compounds may be introduced before, during or after step a).

### Deformation Process

The compositions of the invention have the advantage of having a slow variation in viscosity over a wide temperature range, which makes the behavior of an object of the invention comparable to that of mineral glasses and allows the application thereto of deformation processes that are generally not applicable to standard thermoset resins.

From a practical viewpoint, this implies that within a broad temperature range, an object in accordance with the invention may be fashioned by applying constraints of the order of 1 to 10 MPa without thereby flowing under its own weight.

Similarly, this object can be deformed at a temperature above the Tg temperature, and then, in a second stage, the internal constraints can be removed at a higher temperature.

Without being bound to this explanation, the inventors think that the transesterification exchanges are the cause of the creep and of the variation in viscosity at high temperatures. In terms of application, the objects of the invention may be processed at high temperatures. The low viscosity of these objects at these temperatures notably allows injection molding or press molding. It should be noted that no depolymerization is observed at high temperatures and the objects of the invention conserve their crosslinked structure (which is not the case with Diels-Alder reactions). This property allows the repair of an object of the invention that has come to be fractured into at least two parts by simple welding together of these parts. No mold is needed to maintain the shape of the objects of the invention during the process of repair at high temperatures. Similarly, an object of the invention may be transformed by applying a mechanical constraint to only a part of the object without making use of a mold, since the objects of the invention do not flow. However, large-sized objects, which have a greater tendency to collapse, may be held by a support as in the case of glass-working.

Thus, a subject of the invention is also a process for deforming at least one object as described above, this process comprising: the application to the object of a mechanical constraint at a temperature (T) above room temperature.

Assembly, welding, repair and recycling constitute a particular case of the process for deforming objects according to the invention.

Preferably, to allow deformation within a period that is compatible with industrial application, the deformation process comprises the application to the object of the invention of a mechanical constraint at a temperature (T) above the glass transition temperature Tg of the thermoset resin it contains.

Usually, such a deformation process is followed by a step of cooling to room temperature, optionally with application of at least one mechanical constraint.

For the purposes of the present invention, the term “mechanical constraint” means the application of a mechanical force, locally or to all or part of the object, this mechanical force tending toward forming or deformation of the object. Among the mechanical constraints that may be used, mention may be made of: pressing, molding, blending, extrusion, blow-molding, injection molding, stamping, twisting, flexure, traction and shear. It may be, for example, twisting applied to the object of the invention in strip form. It may be a pressure applied using a plate or a mold onto one or more faces of an object of the invention, or stamping of a pattern in a plate or a sheet. It may also be a pressure exerted in parallel to two objects of the invention in contact with each other so as to bring about welding of these objects. In the case where the object of the invention consists of granules, the mechanical constraints may consist of blending, for example in a mixer or around the screw of an extruder. It may also consist of injection molding or extrusion. The mechanical constraint may also consist of blow-molding, which may be applied, for example, to a sheet of the object of the invention. The mechanical constraint may also consist of a multiplicity of separate constraints, of identical or different nature, applied simultaneously or successively to all or part of the object of the invention, or in a localized manner.

The deformation process in accordance with the invention may include a step of mixing or agglomeration of the object of the invention with one or more additional components chosen from those mentioned previously and in particular: polymers, pigments, dyes, fillers, plasticizers, long or short, woven or nonwoven fibers, flame retardants, antioxidants or lubricants.

The raising of the temperature in the deformation process may be performed by any known means such as heating by conduction, convection, induction, by point, infrared, microwave or radiative heating. The means for bringing about a raising of temperature for the implementation of the processes of the invention comprise: an oven, a microwave oven, a heating resistance, a flame, an exothermic chemical reaction, a laser beam, an iron, a hot-air gun, an ultrasonic tank, a heating punch, etc. The raising of the temperature may or may not be performed in stages and its duration is adapted to the expected result as a function of the following indications and of the examples detailed below.

Although the resin does not flow during its deformation, by means of the transesterification reactions, by choosing an appropriate temperature, heating time and cooling conditions, the new shape may be free of any residual constraint. The object is therefore not rendered fragile or fractured by the application of the mechanical constraint. Furthermore, if the deformed object is subsequently reheated, it will not return to its first shape. Specifically, the transesterification reactions that take place at high temperature promote reorganization of the crosslinking points of the network of the thermoset resin so as to cancel the mechanical constraints. A sufficient heating time makes it possible to fully cancel these mechanical constraints internal to the object that were caused by the application of the external mechanical constraint.

This method thus makes it possible to obtain stable complex forms, which are difficult or even impossible to obtain by molding, from simpler elementary forms. Notably, it is very difficult to obtain forms resulting from twisting by molding.

Additionally, the choice of appropriate temperature, heating time under constraint and cooling conditions makes it possible to transform an object of the invention while at the same time controlling the persistence of certain internal mechanical constraints within this object, and then, if the object thus transformed is subsequently heated, a new controlled deformation of this object by controlled release of the constraints may be performed.

### Recycling Processes

An object of the invention may also be recycled:
either by direct processing of the object: for example, a broken or damaged object of the invention is repaired via a deformation process as described above and may thus regain its prior use function or another function;
or the object is reduced to particles by applying mechanical grinding, and the particles thus obtained are then used in a process for manufacturing an object in accordance with the invention. Notably, according to this process, the particles are simultaneously subjected to a raising of temperature and to a mechanical constraint allowing their transformation into an object in accordance with the invention.

The mechanical constraint allowing the transformation of the particles into an object may comprise, for example, compression in a mold, blending and/or extrusion.

This method notably makes it possible, by applying a sufficient temperature and an appropriate mechanical constraint, to mold novel objects from the objects of the invention.

Another advantage of the invention is that it makes it possible to manufacture objects based on thermoset resin from solid starting materials. These solid starting materials are thus objects according to the invention in the form of pieces, an elementary unit or a set of elementary units.

The term “elementary units” means pieces which have a shape and/or aspect suited to their subsequent transformation into an object, for instance: particles, granules, beads, rods, plates, sheets, films, strips, stems, tubes, etc.

The term “set of elementary units” means at least 2 elementary units, for example at least 3, at least 5, at least 10, or even at least 100 elementary units.

Any process known to those skilled in the art may be used for this purpose. These elementary pieces are then transformable, under the combined action of heat and of a mechanical constraint, into objects having the desired shape: for example, strips may, by stamping, be chopped into smaller pieces of chosen shape, sheets may be superposed and assembled by compression. These elementary pieces based on thermoset resin are more readily storable, transportable and manipulable than the liquid formulations from which they are derived. Specifically, the step of transforming the elementary pieces in accordance with the invention may be performed by the final user without chemical equipment (non-toxicity, no expiry date, no VOCs, no weighing of reagents).

A subject of the invention is thus also a process for manufacturing at least one object based on thermoset resin, which is a particular case of the deformation process already described, this process comprising:
a) the use as starting material of an object of the invention in the form of an elementary unit or a set of elementary units,
b) the simultaneous application of a mechanical constraint and of a raising of temperature for forming the object to form a new object,
c) cooling of the object resulting from step b).

Another advantage of this process is that it allows the recycling of the new object manufactured, this object possibly having been reconditioned in the form of elementary units or pieces that may in turn be reformed, in accordance with the invention.

A subject of the invention is thus also a process for recycling an object of the invention, this process comprising:
a) the use of an object of the invention as starting material,
b) the application of a mechanical constraint and optionally of a simultaneous raising of temperature to transform this object into a set of elementary units,
c) cooling of this set of elementary units.

### Applications

The fields of application of the present invention are mainly those of thermosetting resins, in particular those of epoxy resins, notably the fields of motor vehicles (which includes any type of motorized vehicle including heavy-goods vehicles), aeronautics, water sports, aerospace, sport, construction, electronics, wind power, packaging and printing.

The compositions, materials and objects of the invention may, for example, be incorporated into formulations, notably with typical additives such as fillers, antioxidants, flame retardants, UV protectors, pigments or dyes. The formulations may serve, for example, for coating paper, for manufacturing inks or paints. The materials or objects of the invention may be used in the form of powders or granules, or may be incorporated into composite materials, in particular those comprising glass fibers, carbon fibers, aramid fibers or fibers of plant origin (flax fibers, hemp fibers, etc.). These fibers may be long or short, woven or nonwoven fibers. The compositions of the invention may also be applied as coatings, for example as varnishes for protecting metals, for protecting pipes or for protecting floors.

The compositions of the invention may also serve for manufacturing adhesives, advantageously hot-crosslinkable or photo-crosslinkable adhesives, for encapsulating connectors (the composition of the invention possibly being applied by potting or injection molding), for making electrical insulating pieces or for making prototypes.

### EXAMPLES

The examples that follow illustrate the invention without limiting it.

1-1 Catalyst (C1) with (M1)=zinc

772.7 g of Pripol 1040 (Croda−M_{f}=297 g/mol of carboxylic functions) and 57.3 g of zinc acetate dihydrate (Aldrich−Mw=219.5 g/mol), i.e. a ratio [Zn]/[COON]=10%, are placed in a 1L reactor. The mixture is brought to 80° C. The pressure is gradually lowered to 50 mbar while the heating temperature is raised to 180° C. over 1 hour. After heating for 4 hours at 180° C. (temperature of the medium), 38.9 g of distillate are collected, i.e. 96% of the expected mass. The reaction is stopped and the medium cooled.

1-2 Catalyst (C2) with (M2)=lithium

305.7 g of Pripol 1040 (Croda−M_{f}=297 g/mol of carboxylic functions) and 13.63 g of anhydrous lithium acetate (Aldrich−Mw=66 g/mol), i.e. a ratio [Li]/[COON]=20%, are placed in a 1 L reactor. The mixture is brought to 80° C. The pressure is gradually lowered to 25 mbar while the heating temperature is raised to 190° C. over 1 hour. Distillation of the acetic acid starts at about 120° C. After 1 hour of heating at 180° C. (temperature of the medium), 12 g of distillate are collected, i.e. 97% of the expected mass. The reaction is stopped and the medium cooled.

1-3 Catalyst (C2) with (M2)=cesium

276 g of Pripol 1040 (Croda−M_{f}=297 g/mol of carboxylic functions) and 35.8 g of anhydrous cesium acetate (Aldrich−Mw=192 g/mol), i.e. a ratio [Cs]/[COON]=20%, are placed in a 1 L reactor. The mixture is brought to 80° C. The pressure is gradually lowered to 25 mbar while the heating temperature is raised to 180° C. over 1 hour. Distillation of the acetic acid starts at about 120° C. After 2 hours of heating at 180° C. (temperature of the medium), 9.6 g of distillate are collected, i.e. 86% of the expected mass. The reaction is stopped and the medium cooled.

### 2. Preparation of Compositions and Objects

The compounds used are Pripol 1040 (Croda−M_{f}=297 g/mol of carboxylic functions), BADGE DER 332 and the salts prepared in Example 1, in the proportions indicated in Tables I and II below. The components of part A, preheated to 95° C. in an oven, are placed in a disposable container. The non-preheated part B (stored, however, above its crystallization point) is introduced with stirring in a heating bath of silicone oil brought to 115° C., and the medium is then brought to 115° C. with continuous stirring. When the mixture becomes clear, the medium is poured into a Teflon mold also preheated to 95° C. in an oven. Baking is then performed in the oven for 17 hours at 130° C., followed by cooling for 1 hour to room temperature before stripping from the mold.

TABLE I
(comparative examples)

| | | | II-S1 | | II-S2 | | II-S3 | |
|---|---|---|---|---|---|---|---|---|
| Parts | Component | Metal | m (g) | % | m (g) | % | m (g) | % |
| A | Pripol 1040 | — | — | — | — | — | — | — |
| | I-1 | Zinc | 26.7 | 63 | — | — | — | — |
| | I-2 | Lithium | — | — | 25.15 | 62.9 | — | — |
| | I-3 | Cesium | — | — | — | — | 25.8 | 64.5 |
| B | BADGE DER 332 | — | 15.7 | 37 | 14.84 | 37.1 | 14.2 | 35.5 |

| | | | | | | |
|---|---|---|---|---|---|---|
| TOTAL | 42.4 | 100 | 39.99 | 100 | 40 | 100 |

| | | | |
|---|---|---|---|
| [Metal]/[COOH] | 10% Zn | 20% Li | 20% Cs |

TABLE II

| | | | II-M1 | | II-M2 | | II-M3 | |
|---|---|---|---|---|---|---|---|---|
| Parts | Component | Metal | m (g) | % | m (g) | % | m (g) | % |
| A | Pripol 1040 | — | 6.3 | 15.75 | — | — | 6.2 | 15.5 |
| | I-1 | Zinc | 12.6 | 31.5 | 12.6 | 31.5 | — | — |
| | I-2 | Lithium | 6.3 | 15.75 | — | — | 6.3 | 15.75 |
| | I-3 | Cesium | — | — | 12.9 | 32 | 12.9 | 32.25 |
| B | BADGE DER 332 | — | 14.8 | 37 | 14.5 | 36.5 | 14.6 | 36.5 |

| | | | | | | |
|---|---|---|---|---|---|---|
| TOTAL | 40 | 100 | 40 | 100 | 40 | 100 |

| | | | |
|---|---|---|---|
| [Metal]/[COOH] | 5% Li + 5% Zn | 10% Cs + 5% Zn | 5% Li + 10% Cs |

3. Crosslinking Test

Cylindrical samples of the objects manufactured in Example 2 ((Ø=9 mm, h=6 mm) are maintained completely immersed in a glass flask filled with trichlorobenzene. They are left for 21 hours at 180° C. At room temperature, the samples are then washed and dried and then left overnight in an oven at 140° C. They are then weighed. Table III collates the results obtained, the gel content representing the percentage of the residual mass relative to the initial mass of each sample.

TABLE III

| sample | gel content (%) |
|---|---|
| II-S1 | 83.7 |
| II-S2 | 92.1 |
| II-S3 | 90.4 |
| II-M1 | 81.5 |
| II-M2 | 84.8 |

The high values obtained demonstrate a high degree of crosslinking of the resins and thus confirm their thermoset nature.

### 4. Deformation Tests

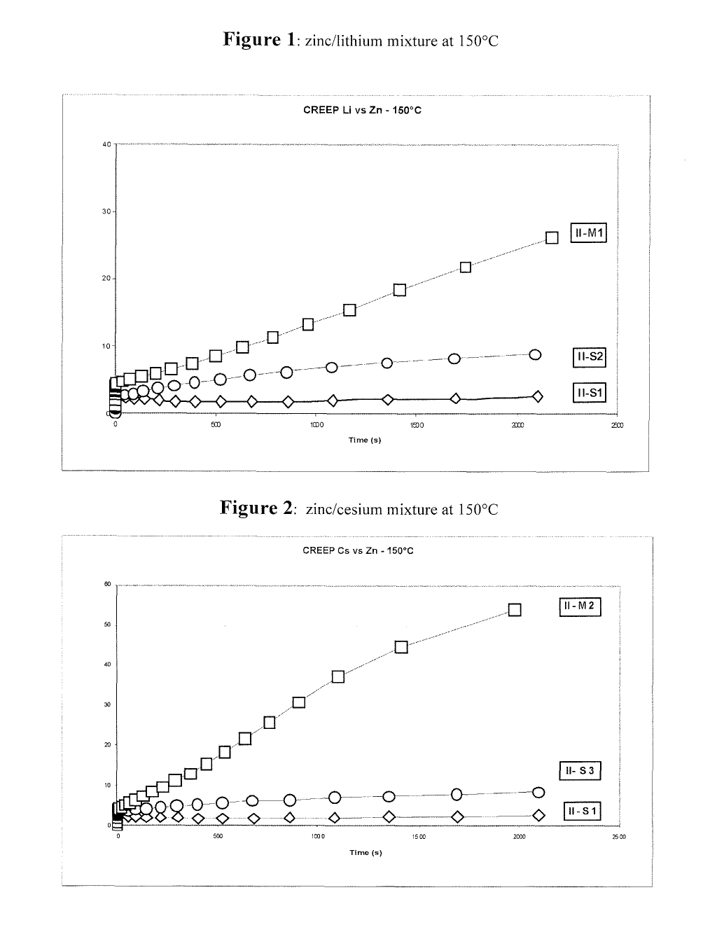

Creep tests on the materials manufactured in Example 2 are performed on a Metravib DMA50N machine. A cylindrical sample 9 mm in diameter and 6 mm long is placed under a constant load of 10N at a stabilized temperature (230° C. or 150° C.). The machine records the degree of deformation of the sample during the loading cycle of 2500 seconds. The stress applied to the sample is 0.16 MPa. The monitoring of the percentage of deformation of the materials over time forms the subject of the attached FIGS. 1, 2 and 3.

FIGS. 1 and 2 show that the use of a composition in accordance with the invention allows the deformation of the material derived therefrom (and thus the possibility of forming it), whereas its mechanical properties are already those of a thermoset resin.

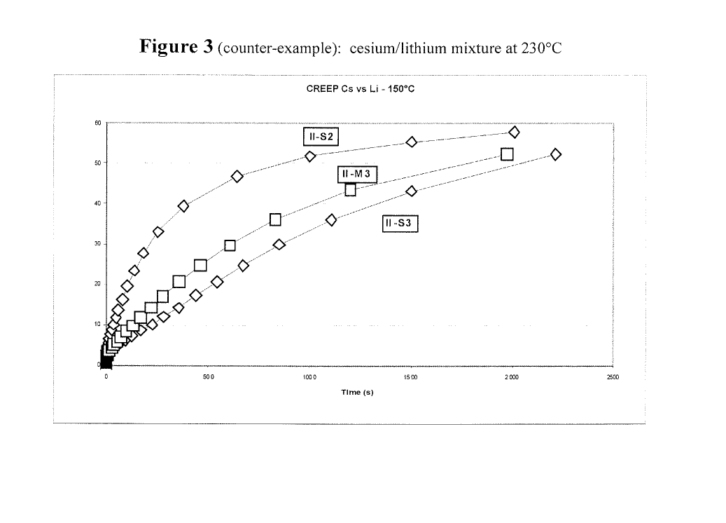

In FIG. 3, sample II-M3 compared with samples II-S2 and II-S3 shows that it is not sufficient to mix two catalysts of the same type (chosen here from those of type (C2)) in order to obtain the advantageous effects of the invention: it is indeed the combined presence of at least two catalysts of different types (C1) and (C2) that makes it possible to obtain a synergistic effect, reflected by the possibility of further deforming the material, without, however, deteriorating it.

1. A composition comprising at least:
a catalyst (C1) comprising at least one atom of an element (M1) selected from the group consisting of: Al, Sc, Ti, Mg, Mn, Fe, Co, Ni, Cu, Zn, Zr, Sn, Hf, Pb, Bi, Sb and In,
a catalyst (C2) comprising at least one atom of an element (M2) selected from the group consisting of alkali metals and alkaline-earth metals, and
at least one of a thermosetting resin or a thermosetting resin hardener.

2. The composition as claimed in claim 1, wherein the total content of catalysts (C1) and (C2) represents from 1% to 70% by weight relative to the total weight of the composition.

3. The composition as claimed in claim 1, wherein the element (M1) is selected from the group consisting of Ti, Mn, Fe, Co, Zn, Zr, Sn and Bi.

4. The composition as claimed in claim 1, wherein the element (M2) is selected from the group consisting of alkali metals.

5. The composition as claimed in claim 1, wherein the catalyst (C1) is a compound of the element (M1) selected from the group consisting of organic and mineral salts, organic and mineral complexes, organometallic molecules and mixtures thereof and the catalyst (C2) is a compound of the element (M2) selected from the group consisting of organic and mineral salts, organic and mineral complexes, and mixtures thereof.

6. The composition as claimed in claim 1, wherein the catalyst (C1) is a compound of the element (M1) and the catalyst (C2) is a compound of the element (M2), these compounds being selected from the group consisting of: phosphates, carbonates, oxides, hydroxides, sulfides; carboxylates comprising at least one —COO⁻ function borne by a linear or branched, saturated or unsaturated hydrocarbon-based chain containing from 1 to 40 carbon atoms, optionally interrupted with one or more heteroatoms chosen from N, O, S and P, or by one or more saturated, partially unsaturated or totally unsaturated hydrocarbon-based rings; alkoxides comprising at least one —O⁻ function borne by a linear or branched, saturated or unsaturated hydrocarbon-based chain containing from 1 to 20 carbon atoms, optionally interrupted with one or more heteroatoms chosen from N, O, S and P, or by one or more saturated, partially unsaturated or totally unsaturated hydrocarbon-based rings; acetylacetonates; diketiminates; and mixtures thereof.

7. The composition as claimed in claim 1, wherein the thermosetting resin comprises at least one epoxide function and optionally at least one free hydroxyl and/or ester function.

8. The composition as claimed in claim 1, wherein the thermosetting resin hardener is selected from the group consisting of carboxylic acids comprising at least two —C(O)OH functions, carboxylic acid anhydrides comprising at least one —C(O)—O—C(O)— function, and mixtures thereof.

9. The composition as claimed in claim 8, wherein the ratio of the number of moles of atoms of elements (M1) and (M2) per mole of —C(O)OH functions or per 0.5 mole of —C(O)—O—C(O)— functions ranges from 1% to 50%.

10. The composition as claimed in claim 1, wherein the content of thermosetting resin and/or of hardener ranges from 10% to 90% by weight, relative to the total weight of the composition, the remainder to 100% being provided by the catalysts (C1) and (C2) and optionally additional compounds.

11. The composition as claimed in claim 1, additionally comprising at least one additional compound selected from the group consisting of: polymers, pigments, dyes, fillers, plasticizers, long and short, woven and nonwoven fibers, flame retardants, antioxidants, lubricants, wood, glass, metals, and mixtures thereof.

12. The composition as claimed in claim 1, additionally comprising at least one of: at least one additional catalyst selected from transesterification catalysts, specific catalysts for epoxide opening, and mixtures thereof; or at least one additional hardener selected from the group consisting of epoxy resin hardeners, and mixtures thereof.

13. The composition as claimed in claim 1, wherein the resin and/or the hardener is present in “activated” form, the atoms of elements (M1) and/or (M2) being complexed with the resin and/or the hardener.

14. An object comprising a thermoset resin obtained from a composition as defined in claim 1.

15. A kit for preparing a composition in accordance with claim 1, comprising at least:
a first composition comprising at least the catalyst (C1),
a second composition comprising at least the catalyst (C2),
a third composition comprising at least the hardener and/or a fourth composition comprising at least the thermosetting resin.

16. A kit for preparing a composition for manufacturing an object in accordance with claim 14, comprising at least:
a first composition comprising at least the catalyst (C1),
a second composition comprising at least the catalyst (C2),
a third composition comprising at least the hardener and
a fourth composition comprising at least the thermosetting resin,
the third and fourth compositions being stored in different compartments.

17. A process for manufacturing an object, comprising:
a) providing a composition in accordance with claim 1 comprising at least the thermosetting resin, the hardener and the catalysts (C1) and (C2);
b) forming the composition obtained in step a);
c) applying an energy for hardening the thermosetting resin to obtain a thermoset resin; and
d) cooling the thermoset resin.

18. A process for deforming an object, comprising applying to an object in accordance with claim 14 a mechanical constraint at a temperature (T) above room temperature.

19. A hot-deformable thermoset resin obtained from a composition in accordance with claim 1, which is free of any residual constraint after its deformation.

20. (canceled)

21. An object in accordance with claim 14, wherein the object is in the form of formulations, powders, granules, coatings, materials or pieces, which are optionally composites.
